(19) United States
(12) Patent Application Publication
(10) Pub. No.: US 2026/0062767 A1
(43) Pub. Date: Mar. 5, 2026

(54) METHOD FOR SEPARATING INDIUM OXIDE AND TIN OXIDE FROM INDIUM TIN OXIDE WASTE TARGET BY VACUUM METHOD

(71) Applicant: Kunming University of Science and Technology, Kunming (CN)

(72) Inventors: Yong DENG, Kunming (CN); Xiumin CHEN, Kunming (CN); Bin YANG, Kunming (CN); Wei LI, Kunming (CN); Jia YANG, Kunming (CN); Qingchun YU, Kunming (CN); Fei WANG, Kunming (CN); Yang TIAN, Kunming (CN); Jiaqi WANG, Kunming (CN)

(21) Appl. No.: 19/317,054

(22) Filed: Sep. 2, 2025

(30) Foreign Application Priority Data
Sep. 3, 2024 (CN) 202411225588.0

(51) Int. Cl. C22B 7/00; C01G 15/00; C01G 19/02

(52) U.S. Cl. CPC C22B 7/004; C01G 15/00; C01G 19/02

(57) ABSTRACT

A method for separating indium oxide and tin oxide from an ITO waste target by a vacuum method disclosed by the present disclosure, which relate to the field of resource recycling and utilization technology. The method Includes: take ITO waste target raw material, add indium to the ITO waste target raw material, heat and hold under vacuum conditions, then the Indium oxide is obtained by the volatilization of the suboxide of indium into the volatile, and the tin oxide is obtained by remaining of the tin oxide in the condensate. The present disclosure is based on the fact that indium oxide can generate volatile suboxide (In₂O) when heated in indium melt, and the generated suboxide can evaporate to the condensation zone for condensation, thereby achieving the separation of indium oxide and tin oxide and achieving resource recovery and utilization of ITO waste target materials.

### CROSS-REFERENCE TO RELATED APPLICATION

This patent application claims the benefit and priority of Chinese Patent Application No. 202411225588.0, entitled “METHOD FOR SEPARATING INDIUM OXIDE AND TIN OXIDE FROM INDIUM TIN OXIDE WASTE TARGET BY VACUUM METHOD” filed with the China National Intellectual Property Administration on Sep. 3, 2024, the disclosure of which is incorporated by reference herein in its entirety as part of the present application.

### TECHNICAL FIELD

The present disclosure relates to the field of resource recycling and utilization technology, in particular to a method for separating indium oxide and tin oxide from an indium tin oxide waste target by a vacuum method.

### BACKGROUND

Indium resources are rare, and there is almost no separate ore body with industrial mining value in nature. It is mostly associated with non-ferrous metal sulfides, and metallic indium is mainly recovered from the smelting by-products of non-ferrous metals and the secondary resources of indium. In the smelting process, tin is often enriched and recovered together with indium because of its similar physical and chemical properties with indium. More than 80% of the output of indium is used to produce indium tin oxide (ITO), and the materials such as scraps and waste targets generated during the production of ITO or waste LCD screens are all the mixtures of ITO.

As a key material for the production of transparent conductive films, the use of ITO is increasing rapidly, so the production of ITO waste targets is also growing rapidly. Indium recovery from ITO waste targets is becoming more and more important for resources, environment and economy. At present, the recovery methods of indium from ITO waste targets at home and abroad are mainly divided into two categories: pyrometallurgy and hydrometallurgy. The pyrometallurgy includes reduction, separation, purification and other processes. The hydrometallurgy includes acid leaching, solvent extraction, ion exchange, etc. The hydrometallurgy recovery is the mainstream process for recovering indium from ITO waste target in industry at present.

(1) Patent document CN1420184A discloses a method for extracting refined indium from ITO waste, in which ITO is dissolved in an acid solution, hydrogen peroxide is added to oxidize Sn²⁺ into Sn⁴⁺ during the indium-tin separation process, and then an inorganic co-precipitant (magnesium sulfate) is added to form a dense precipitate of tin and remove it, with a tin removal rate greater than 99%. (2) Patent document CN101701292A discloses a method for recovering indium and tin from ITO waste target by oxidation. Tin in the solution has two states of bivalent and tetravalent, and tetravalent tin and trivalent indium ions precipitate at a significantly different pH value, so by controlling a certain pH value and using hydrogen peroxide for secondary oxidation, tin ions are oxidized to tetravalent to produce hydrolysis precipitation, while indium remains in the aqueous solution, achieving complete separation for indium and tin, and the content of tin in the separated solution is less than 2 ppm. (3) Patent document CN1487102A discloses a method for recovering indium from indium tin oxide waste target, which includes leaching, impurity removal, replacement, electrolysis and other steps. The impurity removal is carried out under the condition of using sponge indium or indium sheet as purifying agent at 25 to 60 K, and the tin in the solution after impurity removal is less than 0.1 g/L. (4) Patent document CN101463425A discloses a method for extracting and separating indium and tin from an indium-tin mixed solution, in which P₂₀₄ is used to simultaneously extract indium and tin from an acidic solution system containing indium and tin, and 0.5 to 3 mol/l fluoride (HF, NaF, NH₄F) is used to complex and strip tin. After acid washing, the stripping solution is stripped with 4 to 6 mol/l hydrochloric acid to obtain a high-purity indium solution and high-purity tin solution, achieving complete separation of indium and tin. (5) Patent document CN101528988A discloses a method for recovering a valuable metal from ITO waste, in which the ITO waste is electrolyzed as an anode to recover indium, an electrolytic bath is separated between the anode and the cathode by a diaphragm or an anion exchange membrane, the anolyte is extracted to remove tin, and the purified solution is charged to the cathode side for electrolysis, so that the metal indium can be selectively recovered. The method for removing the tin can adopt a neutralization method, a displacement method, a meta-stannic acid method, a hydrolysis method and the like, and a small amount of tin remains in the anolyte. (6) Patent document CN101104883A discloses a method for recovering indium and tin from ITO waste by acid leaching-sulfide precipitation combined process, in which sodium sulfide is added to the indium and tin leaching solution to remove tin from the solution as sulfide precipitate. (7) Patent document CN101660056 a method for separating indium and tin from indium-tin alloy by vacuum distillation and patent document CN201567361U a production device for continuously removing tin from crude indium respectively disclose a method and a device for separating indium and tin by vacuum distillation. (8) Patent document CN103194625A discloses a method for separating tin-indium alloy”, which sprays industrial oxygen with a purity of 93-98.5% onto the surface of tin-indium alloy at 850 to 1250 K to oxidize all tin and indium into oxides, and then leaches them with 80 to 100 g/L acid and filters them. The obtained filter residue is reduced and smelted to produce crude tin, and the filtrate is subjected to conventional extraction, tripping and displacement to obtain crude indium, achieving the separation of tin and indium. (9) Patent document CN1757768A discloses a method for separating an indium-tin mixture, which uses a two-stage leaching displacement method to separate indium and tin. Firstly, zinc powder is added to the acid solution of the indium tin mixture to replace tin ions with solid tin, and solid-liquid separation is achieved to separate tin and indium. Tin slag is soaked in concentrated nitric acid to remove impurities, and then reduced and melted with coke powder to obtain crude tin. Replace the tin removal solution with zinc sheets to obtain sponge indium, which is then pressed and melted into crude indium. (10) Patent document CN101701291A discloses a method for recovering indium and tin from ITO waste target by distillation, utilizes the low boiling point of SnCl₄ under normal pressure and a certain range of sublimation temperature with InCl₃ to separate the chloride salt of indium tin through distillation. The ITO waste target is leached with hydrochloric acid, and an appropriate amount of oxidant is added after leaching to oxidize Sn²⁺ to Sn⁴⁺. Distillation is carried out at 120 to 140 K for 3 to 9 hours, and the distillate and residue are collected separately. The residue is dissolved in dilute hydrochloric acid, replaced with an aluminum plate, and alkali melted to obtain crude indium.

The hydrometallurgical recovery process of ITO waste target is as follows: firstly, the ITO target material is pretreated and leached, the leachate is treated to separate indium and tin, extract and refine indium, and finally obtain refined indium. The key of hydrometallurgical recovery is the separation of indium and tin from solution. The separation methods include metal replacement, solvent extraction, sulfide precipitation, neutralization and so on. Han Qiying et al. recovered indium from ITO waste targets by acid dissolution, replacement and alkali fusion. Liu Zhihong et al. used the different solubility products of In₂S₃ and SnS to separate indium and tin by sulfide precipitation. Indium was recovered from waste ITO targets by Sheng-Jen Hsieh using hydrometallurgy and hot-maceration method. Li Yanhui et al. recovered indium from ITO waste target by acid leaching, secondary replacement and alkali fusion. Jung-Chul adopted a new method to remove tin and enriched indium metal from ITO target waste by hydrothermal reaction in alkaline solution. Gu et al. proposed a process for separating indium and tin by chlorination distillation and crystallization, and Wen Zhipeng et al. proposed a leaching process for strengthening ITO waste target by microwave pretreatment.

The pyrometallurgical recovery process of ITO waste target mainly includes two steps: the reduction of oxide and the separation of indium and tin. Chen Jian et al. used hydrogen reduction-secondary molten salt electrolysis; Xu et al. used H₂ to directly reduce ITO waste targets; He Yunxia et al. used a vacuum carbothermal reduction method to recover indium from ITO waste targets; Deng Yong et al. used a carbothermal reduction-vacuum distillation method to recover indium from ITO waste targets; Itoh et al. used CO—CO₂ mixed gas as a reducing agent to directly reduce ITO waste targets; Ma En et al. used a crude vacuum chlorination separation method to recover indium from ITO waste targets; Wang Ruixue et al. used in-situ pyrolysis reduction waste liquid crystal panel (LCD) to prepare indium and tin; and Wang Hongyu et al. used a one-step vacuum carbothermal reduction method to directly recover indium and tin from ITO waste targets.

Other recovery processes for ITO waste targets: Ogi et al. developed a biosorption system for recovering indium using bacteria and algae; Higashi et al. recovered indium from ITO using a microorganism (Shiwanella sp.). Wang yuanyuan et al. used molten salt electrolysis to recover indium from ITO waste target; Su Xianwei et al. explored a method of directly electrolyzing s-ITO in CaO—CaCl₂ molten salt by using s-ITO (waste target) instead of graphite anode.

The key of the recovery process of ITO waste target lies in the separation of indium and tin. The methods described in the prior art mainly adopt hydrometallurgy, vacuum distillation method or sulfide precipitation method. These methods have the technical problems of long process, incomplete separation of indium and tin, and introduction of new impurities in the reduction process.

Therefore, it is necessary to study a method for separating indium oxide and tin oxide from an indium tin oxide waste target by a vacuum method to solve the above technical problems.

### SUMMARY

The objectives of the present disclosure is to provide a method for separating indium oxide and tin oxide from an indium tin oxide (ITO) waste target by a vacuum method, which is based on the fact that indium oxide can generate volatile suboxide (In₂O) when heated in indium melt, and the generated suboxide can evaporate to the condensation zone for condensation, thereby achieving the separation of indium oxide and tin oxide.

In order to achieve the above objectives, the present disclosure provides a method for separating indium oxide and tin oxide from an ITO waste target by a vacuum method including the following steps.
(1) Take an ITO waste target raw material, add indium to the ITO waste target raw material, heat and hold under vacuum conditions.
(2) Indium oxide is obtained by the volatilization of the suboxide of indium into the volatile, and tin oxide is obtained by remaining of the tin oxide in the condensate.

Furthermore, the molar ratio of indium oxide to indium in the ITO waste target raw material in the step (1) is 1:1 to 4.

Furthermore, the pressure under the vacuum conditions in the step (1) is 5 to 20 Pa.

Furthermore, the heating temperature in the step (1) is between 1050 to 1250 K.

Furthermore, the holding time in the step (1) is 30 to 60 minutes.
1. The separation method of the present disclosure can separate indium oxide and tin oxide from ITO waste target materials without introducing other impurities.
2. The separation method of the present disclosure achieves the separation of indium oxide and tin oxide in ITO waste target materials, thereby realizing the resource recovery and utilization of ITO waste target materials based on the fact that indium oxide can generate volatile suboxide (In₂O) when heated in indium melt, and the generated suboxide can evaporate to the condensation zone for condensation.

### DETAILED DESCRIPTION OF THE EMBODIMENTS

Embodiments of the present disclosure will be described in detail below, examples of which are illustrated in the accompanying drawings, wherein the same reference numeral or the similar reference numerals indicate the same element or the similar elements or elements having the same function or the similar functions throughout. The embodiments described below by way of example with reference to the accompanying drawings are intended to explain the disclosure and are not to be construed as limiting the disclosure. In the description of the present disclosure, “a plurality”means two or more unless specifically defined otherwise.

### Embodiment 1

The method for separating ITO by a vacuum method includes the following steps.

According to the molar ratio of indium oxide to indium in the ITO waste target raw material of 1:1, the ITO waste target raw material (ITO target material) and indium were weighed and put into a graphite crucible; then the graphite crucible was put into a vacuum furnace, the pressure in the vacuum furnace was 5 Pa, the temperature was raised to 1073 K, and the temperature was kept for 60 minutes. After the holding is finished, the vacuum furnace was opened, and the distillate and the residue were respectively taken out. The metal indium formed the suboxide of the indium which volatilized into the volatile, and the tin oxide in the ITO target remained in the condensate, thereby realizing the separation of the indium oxide and the tin oxide in the ITO target.

### Embodiment 2

The method for separating ITO by a vacuum method includes the following steps.

According to the molar ratio of indium oxide to indium in the ITO waste target raw material of 1:4, the ITO waste target raw material (ITO target material) and indium were weighed and put into a graphite crucible; then the graphite crucible was put into a vacuum furnace, the pressure in the vacuum furnace was 10 Pa, the temperature was raised to 1223 K, and the temperature was kept for 30 minutes. After the holding is finished, the vacuum furnace was opened, and the distillate and the residue were respectively taken out. The metal indium formed the suboxide of the indium which volatilized into the volatile, and the tin oxide in the ITO target remained in the condensate, thereby realizing the separation of the indium oxide and the tin oxide in the ITO target.

### Embodiment 3

The method for separating ITO by a vacuum method includes the following steps.

According to the molar ratio of indium oxide to indium in the ITO waste target raw material of 1:2, the ITO waste target raw material (ITO target material) and indium were weighed and put into a graphite crucible; then the graphite crucible was put into a vacuum furnace, the pressure in the vacuum furnace was 20 Pa, the temperature was raised to 1173 K, and the temperature was kept for 60 minutes. After the holding is finished, the vacuum furnace was opened, and the distillate and the residue were respectively taken out. The metal indium formed the suboxide of the indium which volatilized into the volatile, and the tin oxide in the ITO target remained in the condensate, thereby realizing the separation of the indium oxide and the tin oxide in the ITO target.

### Embodiment 4

The method for separating ITO by a vacuum method includes the following steps.

According to the molar ratio of indium oxide to indium in the ITO waste target raw material of 1:1, the ITO waste target raw material (ITO target material) and indium were weighed and put into a graphite crucible; then the graphite crucible was put into a vacuum furnace, the pressure in the vacuum furnace was 10 Pa, the temperature was raised to 1050 K, and the temperature was kept for 40 minutes. After the holding is finished, the vacuum furnace was opened, and the distillate and the residue were respectively taken out. The metal indium formed the suboxide of the indium which volatilized into the volatile, and the tin oxide in the ITO target remained in the condensate, thereby realizing the separation of the indium oxide and the tin oxide in the ITO target.

### Embodiment 5

The method for separating ITO by a vacuum method includes the following steps.

According to the molar ratio of indium oxide to indium in the ITO waste target raw material of 1:3, the ITO waste target raw material (ITO target material) and indium were weighed and put into a graphite crucible; then the graphite crucible was put into a vacuum furnace, the pressure in the vacuum furnace was 10 Pa, the temperature was raised to 1250 K, and the temperature was kept for 50 minutes. After the holding is finished, the vacuum furnace was opened, and the distillate and the residue were respectively taken out. The metal indium formed the suboxide of the indium which volatilized into the volatile, and the tin oxide in the ITO target remained in the condensate, thereby realizing the separation of the indium oxide and the tin oxide in the ITO target.

In summary, the preparation method of the present disclosure is based on the fact that indium oxide can generate volatile suboxide (In₂O) when heated in indium melt, and the generated suboxide can evaporate to the condensation zone for condensation, thereby achieving the separation of indium oxide and tin oxide. The separation method can separate indium oxide and tin oxide from ITO waste target materials without introducing other impurities, achieving resource recovery and utilization of ITO waste target materials.

The above disclosed embodiments are only partial embodiments of the present disclosure and cannot be used to limit the scope of the present disclosure. Those of ordinary skill in the art can understand the entire process or the partial process for implementing the above embodiments, and equivalent changes made according to the claims of the present disclosure still fall within the scope of the present disclosure.

What is claimed is:

1. A method for separating indium oxide and tin oxide from an indium tin oxide (ITO) waste target by a vacuum method, comprising:
(1) taking an ITO waste target raw material, adding indium to the ITO waste target raw material, and heating and holding under vacuum conditions; and
(2) after an end of insulation, obtaining indium oxide by volatilization of suboxide of indium into a volatile, and obtaining tin oxide by remaining of tin oxide in condensate;
wherein, a heating temperature in the step (1) is between 1050 to 1250 K.

2. The method for separating indium oxide and tin oxide from an ITO waste target by a vacuum method according to claim 1, wherein a molar ratio of indium oxide to indium in the ITO waste target raw material in the step (1) is 1:1 to 4.

3. The method for separating indium oxide and tin oxide from an ITO waste target by a vacuum method according to claim 1, wherein pressure under the vacuum conditions in the step (1) is 5 to 20 Pa.

4. The method for separating indium oxide and tin oxide from an ITO waste target by a vacuum method according to claim 1, wherein holding time in the step (1) is 30 to 60 minutes.
